(19) United States
(12) Patent Application Publication
(10) Pub. No.: US 2004/0051743 A1
(43) Pub. Date: Mar. 18, 2004

(54) Printer icon generating system

(75) Inventor: Haruyoshi Gonsho, Kawasaki-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/389,917

(22) Filed: Mar. 18, 2003

(30) Foreign Application Priority Data
Sep. 13, 2002 (JP) 2002-268318

(51) Int. Cl. G09G 5/00

(52) U.S. Cl. 345/847

(57) ABSTRACT

According to the present invention, there is provided a printer icon generating system for performing a printing operation with a predetermined printing attribute only by a simple operation. A CPU acquires the driver attribute of a printer or a device attribute, and then determines whether or not the printer can perform a double-sided printing operation. As a result, when the double-sided printing operation can be performed, the CPU generates a printer icon of “<printer name>_double sided_2up” with respect to the printer by the use of a copied printer icon. Further, the CPU sets a printing attribute with respect to the printer icon.

### BACKGROUND OF THE INVENTION

1. Field of the Invention

The present invention relates to a printer icon generating apparatus, a printer icon generating method, and a recording medium having a printer icon generation control command recorded thereon. More particularly, the invention relates to a printer icon generating apparatus for generating an icon, which instructs a printing operation with a predetermined printing attribute, a printer icon generating method, and a recording medium having a printer icon generation control command recorded thereon.

2. Description of the Related Art

Conventionally, a user can designate a printing attribute (Nup: 1up/2up/4up; or double sided/single sided) in the operating system (abbreviated as “the OS”) of a so-called personal computer, and then, he or she can perform a printing operation. “Nup” herein signifies that images of N pages are made up with respect to one sheet of paper and printed thereon. Here, when the user designates the printing attribute, he or she designates the printing attribute via a dialog box displayed at the time of the printing operation or creates a plurality of printer icons contained in a printer folder, and then, designates a specified value of the printing attribute via properties (see, for example, Craig Stinson and Carl Siechert “Official Manual of Microsoft (registered trademark) Windows (R) NT Workstation ver. 4.0”, ASCII, pp. 218-219).

However, a conventional method for setting the printing attribute has required the operation by the user. That is to say, unless the user knows the method for setting the printing attribute, he or she could not obtain a printout with his or her desired printing attribute. From the viewpoint of document management of ISO 14001, it is desirable to reduce the output of sheets, and therefore, there has been a demand for easy designation of the printing attribute.

### SUMMARY OF THE INVENTION

The present invention has been accomplished in an attempt to solve the above problems observed in the prior art. An object of the invention is to provide a printer icon generating apparatus capable of performing a printing operation with a predetermined printing attribute only by a simple operation, a printer icon generating method, and a recording medium having a printer icon generation control command recorded thereon.

According to a first aspect of the invention, there is provided a printer icon generating apparatus comprising: a printer selecting component for selecting a printer; a printer characteristic acquiring component for acquiring a printer characteristic of the printer selected by the printer selecting component; and an icon generating component for generating an icon, which instructs a printing operation with a predetermined printing attribute in accordance with the printer characteristic acquired by the printer characteristic acquiring component.

According to a second aspect of the invention, there is provided a printer icon generating method comprising the steps of: (a) selecting a printer; (b) acquiring a printer characteristic of the printer selected in the step (a); and generating an icon, which instructs a printing operation with a predetermined printing attribute in accordance with the printer characteristic acquired in the step (b).

According to a third aspect of the invention, there is provided a recording medium having a printer icon generation control command to be executed by a computer recorded thereon, the printer icon generation control command comprising the steps of: (a) selecting a printer; (b) acquiring a printer characteristic of the printer selected in the step (a); and (c) generating an icon, which instructs a printing operation with a predetermined printing attribute in accordance with the printer characteristic acquired in the step (b).

Here, the first and second aspects of the invention can be implemented by installing, in the computer, the printer icon generation control command recorded on the recording medium according to the third aspect of the invention.

The printer selecting component selects one or more printers from among, for example, a plurality of printers in accordance with, for example, an operation by a user. The printer characteristic acquiring component acquires the printer characteristic of the printer selected by the printer selecting component. Here, it is preferable that the printer characteristic should be information representing whether or not the printer can perform a double-sided printing operation.

The icon generating component determined the printing attribute, with which the printing operation can be performed, in accordance with the printer characteristic acquired by the printer characteristic acquiring component, and then, generates the icon which instructs the printing operation with the predetermined printing attribute which has been determined. Therefore, the icon generating component may generate a plurality of icons which instruct the printing operation with the respective printing attributes in such a manner that the printing operation can be performed with each of the printing attributes in the case where there are a plurality of printing attributes, with which the printing operation can be performed.

Thus, according to the first to third aspects of the invention, it is possible to readily perform the printing operation with the predetermined printing attribute by just clicking a desired icon even when the user has no knowledge of a printer driver or the like by acquiring the printer characteristic of the selected printer, and then, generating the icon which instructs the printing operation with the predetermined printing attribute in accordance with the acquired printer characteristic.

In the first aspect of the invention, the printer characteristic acquiring component may acquire the driver attribute of the printer or device information as the printer characteristic.

In the second aspect of the invention, the driver attribute of the printer or device information may be acquired as the printer characteristic in the printer characteristic acquiring step.

In the third aspect of the invention, the driver attribute of the printer or device information may be acquired as the printer characteristic in the printer characteristic acquiring step.

Thus, it is possible to acquire the driver attribute of the printer or the device information as the printer characteristic, and then, to determine the printing attribute, with which the printing operation can be performed, based on the driver attribute of the printer or the device information, thereby readily generating the icon which instructs the printing operation with the predetermined printing attribute.

In the first aspect of the invention, the icon generating component may generate an icon instructing a printing operation with at least one printing attribute among 2-page printing on single sided, 1-page printing on double sided and 2-page printing on double sided.

In the second aspect of the invention, an icon instructing a printing operation with at least one printing attribute among 2-page printing on single sided, 1-page printing on double sided and 2-page printing on double sided may be generated in the icon generating step.

In the third aspect of the invention, an icon instructing a printing operation with at least one printing attribute among 2-page printing on single sided, 1-page printing on double sided and 2-page printing on double sided may be generated in the icon generating step.

Thus, it is possible to perform the printing operation with at least one printing attribute among 2-page printing (2up) on single sided, 1-page printing (1up) on double sided and 2-page printing (2up) on double sided only with a simple click of the icon.

As described above, according to the printer icon generating apparatus, the printer icon generating method, and the recording medium having the printer icon generation control command recorded thereon according to the invention, it is possible to readily perform the printing operation with the predetermined printing attribute only with a just click of a desired icon even when the user has no knowledge of a printer driver or the like by acquiring the printer characteristic of the selected printer, and then, generating the icon which instructs the printing operation with the predetermined printing attribute in accordance with the acquired printer characteristic.

### BRIEF DESCRIPTION OF THE DRAWINGS

FIG. 1 is a block diagram illustrating the configuration of a printer control network in an embodiment according to the present invention.

FIG. 2 is a flowchart illustrating processing procedures when a CPU in a printer icon generating apparatus generates a new printer icon having a predetermined printing attribute.

FIG. 3 is a diagram illustrating a printer icon generating screen displayed on an LCD.

FIG. 4 is a diagram illustrating a completion message displayed on the LCD.

FIG. 5 is a diagram conceptually illustrating the contents of an XML file.

### DESCRIPTION OF THE PREFERRED EMBODIMENT

A preferred embodiment according to the present invention will be described below in reference to the accompanying drawings.

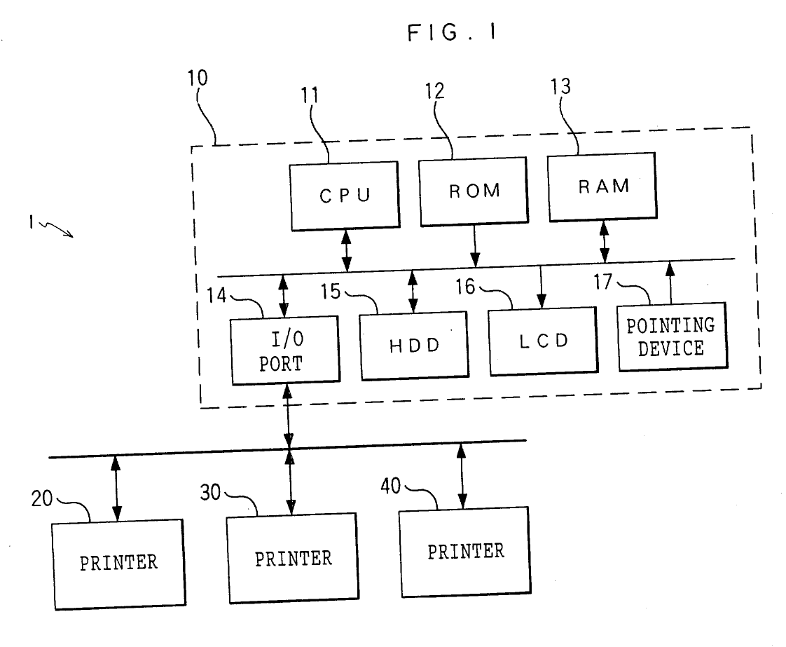

FIG. 1 is a block diagram illustrating the configuration of a printer control network 1 in an embodiment according to the invention. The printer control network 1 comprises a printer icon generating apparatus 10 and printers 20, 30 and 40.

The printer icon generating apparatus 10 is constituted of a so-called personal computer. Here, in the printer icon generating apparatus 10 are installed a document editing application program, printer drivers for the respective printers 20, 30 and 40, and a printer icon generation control command, described later.

As illustrated in FIG. 1, the printer icon generating apparatus 10 includes a CPU 11 for performing arithmetic processing, a ROM 12 having control programs for the CPU 11 stored therein, a RAM 13 serving as a work area of data, an input/output (I/O) port 14 for performing the input or output of the data, a hard disk drive 15 having application programs and the like stored therein, a liquid crystal display (LCD) 16 for displaying a document being edited, an icon and the like thereon, and a pointing device 17 for pointing a position on the LCD 16.

The hard disk drive 15 has stored therein the document editing application program, the printer drivers for the respective printers 20, 30 and 40, and the printer icon generation control program, described later. The printer icon generation control program holds values regarding printing attributes and generates printer icons, which are icons for instructing printing for printers with predetermined printing attributes.

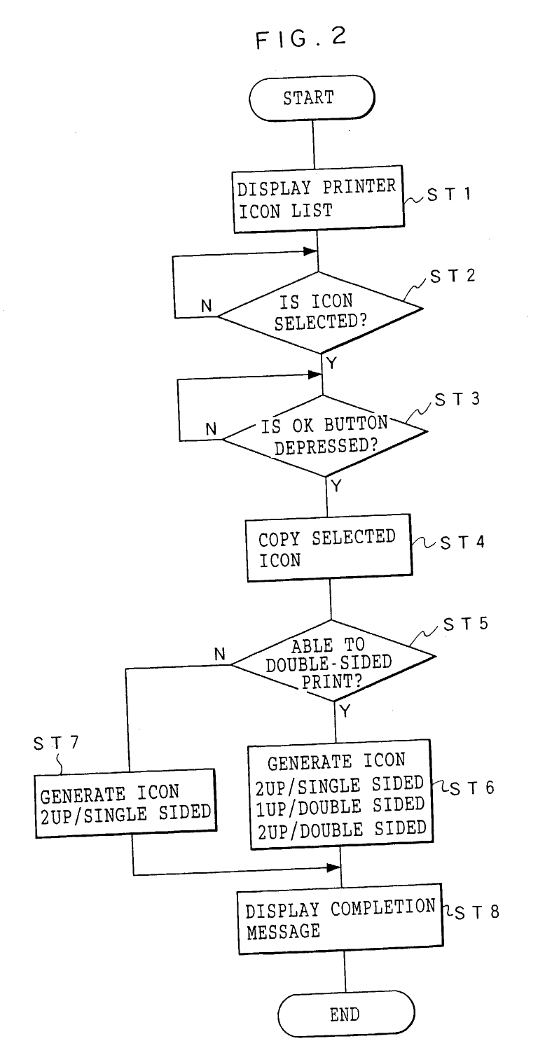

FIG. 2 is a flowchart illustrating processing procedures when the CPU 11 in the printer icon generating apparatus 10 generates a new printer icon having a predetermined printing attribute.

In step ST1, the CPU 11 displays a printer icon generating screen.

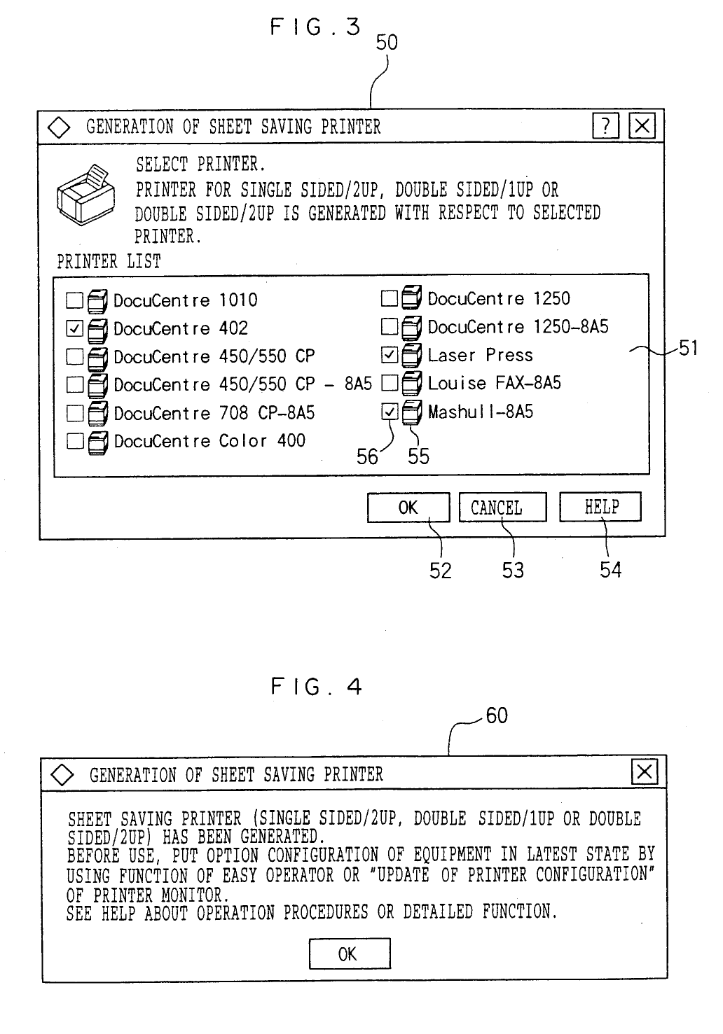

FIG. 3 is a diagram illustrating a printer icon generating screen 50 displayed on the LCD 16. The printer icon generating screen 50 includes a printer list 51, an OK button 52 for instructing the implementation of generation of a new printer icon, a cancel button 53 for instructing an end without performing anything, and a help button 54 for instructing a help screen is to be displayed.

On the printer list 51, there are displayed printer icons 55 representing all printers, each of which uses a given printing driver and can perform a printing operation, and check boxes 56 indicating whether or not any of the printer icons 55 is selected. Note that there is not displayed an icon of a printer which uses a facsimile transmitting driver.

Furthermore, there is not displayed an icon of a shared printer whose name is started with a back slash, (or with ‘¥’ in Japan). All of defaults of the check boxes 56 are OFF, that is, in the state in which none of them are selected.

The plurality of printer icons 55 displayed on the printer list 51 cannot be selected at one time. Therefore, a user may simply click the check boxes 56 corresponding to the printer icons 55 one by one in the case where the user selects the plurality of printer icons 55.

In step ST2, the CPU 11 determines whether or not at least one of the icons displayed on the printer list 51 is selected. The CPU 11 waits and keeps the OK button 52 grayed out until at least one of the icons is selected. Upon detection of the selection of at least one of the icons (for example, an icon corresponding to the printer 20), the CPU 11 releases the OK button 52 from being grayed out. Thus, the routine proceeds to step ST3.

In step ST3, the CPU 11 waits until the OK button 52 is clicked. As soon as the CPU 11 detects the click of the OK button 52, the routine proceeds to step ST4.

In step ST4, the CPU 11 copies the printer driver of the printer 20 together with the printer icon selected in step ST2. Thus, the routine proceeds to step ST5.

In step ST5, the CPU 11 acquires the driver attribute of the printer 20 or a device attribute, to thus determine whether or not the printer 20 can perform a double-sided printing operation. When the determination result is affirmative, the routine proceeds to step ST6; in contrast, when the determination result is negative, the routine proceeds to step ST7.

In step ST6, the CPU 11 generates a printer icon of “<printer name>_single sided_{—}2up” instructing that the printer 20 prints 2 pages on single sided of a sheet by the use of the copied printer icon (the printer driver or the like). Moreover, the CPU 11 sets printing attributes of no double-sided printing and Nup=“2up/forward” with respect to the printer icon of “<printer name>_single sided_{—}2up”.

Additionally, the CPU 11 generates a printer icon of “<printer name>_double sided” instructing that the printer 20 prints 1 page on each side of a sheet by the use of the copied printer icon. In addition, the CPU 11 sets printing attributes of double-sided printing=“longitudinal binding” and Nup=“1up” with respect to the printer icon of “<printer name>_double sided”.

In the same manner, the CPU 11 generates a printer icon of “<printer name>_double sided_{—}2up” instructing that the printer 20 prints 2 pages on each side of a sheet by the use of the copied printer icon. Furthermore, the CPU 11 sets printing attributes of double-sided printing=“longitudinal binding” and Nup=“2up/forward” with respect to the printer icon of “<printer name>_double sided_{—}2up”. Thus, the routine proceeds to step ST8.

In the meantime, in step ST7, the CPU 11 generates a printer icon of “<printer name>_single sided_{—}2up” instructing that the printer 20 prints 2 pages on a single side of a sheet by the use of the copied printer icon. Furthermore, the CPU 11 sets printing attributes of no double-sided printing and Nup=“2up/forward” with respect to the printer icon of “<printer name>_single sided_{—}2up”. Thus, the routine proceeds to step ST8.

Incidentally, attributes regarding preset driver options (for example, a name of a job owner, a color mode and a document monitor) are taken over by a printer icon newly generated in step ST6 or ST7. Other attributes can be updated in “the update of the printer configuration” in a printer monitor.

In step ST8, the CPU 11 displays a completion message on the LCD 16 and outputs an XML file in order to prompt the user to put the printer configuration in a latest state.

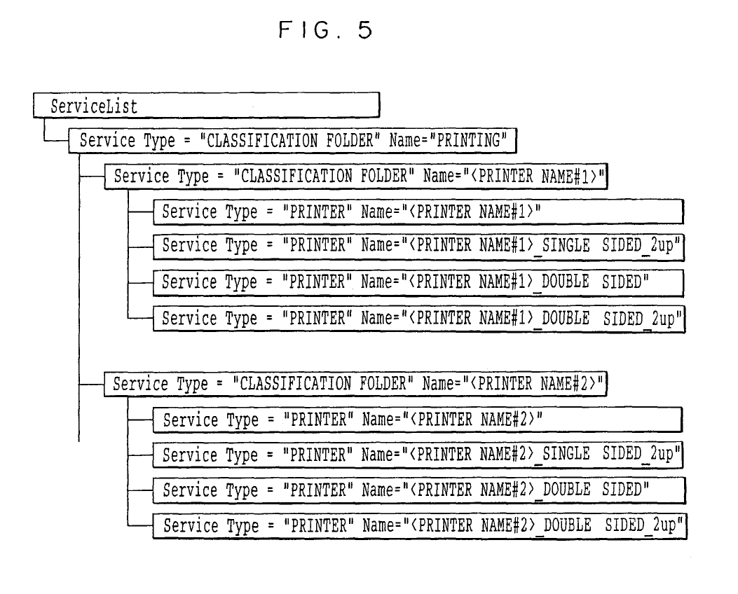

FIG. 4 is a diagram illustrating a completion message 60 displayed on the LCD 16 when the routine proceeds to step ST8 via step ST6. FIG. 5 is a diagram conceptually illustrating the contents of the XML file. Upon detection of the click of an OK button 61 of the completion message 60, the CPU 11 closes the completion message 60, and thus, the routine comes to an end.

Incidentally, the CPU 11 displays the completion message representing the generation of only the printer icon of “<printer name>_single sided_{—}2up” on the LCD 16 when the routine proceeds to step ST8 via step ST7.

Otherwise, the CPU 11 displays the completion message representing the generation of only the printer icon of “<printer name>_single sided_2up” when two or more printer icons 55 are selected in step ST2 and the routine proceeds to step ST8 via step ST7 in regard to one printer, and then, the processings in step ST4 onwards are executed in regard to the next printer in the same manner.

As described above, in the printer control network 1 in the embodiment according to the invention, the printer icon generating apparatus 10 can automatically generate the printer icon previously set in the predetermined printing attribute (“2up/single sided”, “1up/double sided” and “2up/double sided”) only with the selection of the desired printer by the user.

In this manner, the user can perform the printing operation with the predetermined printing attribute simply by clicking the desired printer icon without setting any printing attribute at the time of the printing operation. In other words, it is possible to perform the printing operation with the predetermined printing attribute by a just clicking the desired printer icon even when the user has no knowledge of the printer driver or the like.

It is to be understood that the invention is not restricted to the particular embodiment given above, and that various modifications in terms of design may be added thereto. Although the printer icon generating apparatus 10 has been exemplified by, for example, the personal computer, in which the printer icon generation control command is installed, the printer icon generating apparatus may be a work station for use in a server or the like.

Furthermore, although the printing attribute has been exemplified by the combination of 1up/2up and single sided/double sided, the invention is not restricted to the particular embodiment given above. For example, the printing attributes may include 4up/8up, an output sheet side, the orientation of a document, a font, graphics, tray/discharge and the like.

What is claimed is:

1. A printer icon generating apparatus comprising:
a printer selecting component for selecting a printer;
a printer characteristic acquiring component for acquiring a printer characteristic of the printer selected by the printer selecting component; and
an icon generating component for generating an icon, which instructs a printing operation with a predetermined printing attribute in accordance with the printer characteristic acquired by the printer characteristic acquiring component.

2. The printer icon generating apparatus of claim 1, wherein the printer characteristic acquiring component acquires at least one of a driver attribute and device information of the printer as the printer characteristic.

3. The printer icon generating apparatus of claim 1, wherein the printer characteristic is information representing whether or not the printer can perform a double-sided printing operation.

4. The printer icon generating apparatus of claim 1, wherein the icon generating component generates an icon instructing a printing operation, which includes at least one printing attribute among printing 2-pages on a single side, printing 1-page on each side and printing 2-page on each side.

5. The printer icon generating apparatus of claim 1, wherein the icon generating component generates an icon instructing a printing operation by setting, to be a predetermined attribute, at least one printing attribute among a sheet size, an orientation of a document, a font, graphics, tray/discharge and a number of pages to be one of single sided and double sided printed.

6. A printer icon generating method comprising the steps of:
(a) selecting a printer;
(b) acquiring a printer characteristic of the printer selected in the step (a); and
(c) generating an icon, which instructs a printing operation with a predetermined printing attribute in accordance with the printer characteristic acquired in the step (b).

7. The printer icon generating method of claim 6, wherein at least one of a driver and device information of the printer is acquired as the printer characteristic in the step (b).

8. The printer icon generating method of claim 6, wherein the printer characteristic is information representing whether or not the printer can perform a double-sided printing operation.

9. The printer icon generating method of claim 6, wherein an icon instructing a printing operation with at least one printing attribute among printing 2-pages on a single sided, printing 1-page on each side and printing 2-pages on each side is generated in the step (c).

10. The printer icon generating method of claim 6, wherein an icon instructing a printing operation by setting, to be a predetermined attribute, at least one printing attribute among a sheet size, an orientation of a document, a font, graphics, tray/discharge and a number of pages to be one of single sided and double sided printed is generated in the step (c).

11. A recording medium having a printer icon generation control command to be executed by a computer recorded thereon, the printer icon generation control command comprising the steps of:
(a) selecting a printer;
(b) acquiring a printer characteristic of the printer selected in the step (a); and
(c) generating an icon, which instructs a printing operation with a predetermined printing attribute in accordance with the printer characteristic acquired in the step (b).

12. The recording medium of claim 11, wherein at least one of a driver attribute and device information of the printer is acquired as the printer characteristic in the step (b).

13. The recording medium of claim 11, wherein the printer characteristic is information representing whether or not the printer can perform a double-sided printing operation.

14. The recording medium of claim 11, wherein an icon instructing a printing operation with at least one printing attribute among printing 2-pages on a single side, printing 1-page on each side and printing 2-pages on each side is generated in the step (c).

15. The recording medium of claim 11, wherein an icon instructing a printing operation by setting, to be a predetermined attribute, at least one printing attribute among a sheet size, an orientation of a document, a font, graphics, tray/discharge and a number of pages to be one of single sided and double sided printed is generated in the step (c).
